(19) United States
(12) Patent Application Publication
(10) Pub. No.: US 2026/0176917 A1
(43) Pub. Date: Jun. 25, 2026

(54) Type of guardrail door structure

(71) Applicant: Zhongshan Chenbei Daily Necessities Co., Ltd., Zhongshan City (CN)

(72) Inventor: Xin Guo, Zhongshan City (CN)

(73) Assignee: Zhongshan Chenbei Daily Necessities Co., Ltd., Zhongshan City (CN)

(21) Appl. No.: 19/235,349

(22) Filed: Jun. 11, 2025

(30) Foreign Application Priority Data
Dec. 25, 2024 (CN) 202423216192.8

(51) Int. Cl. E06B 9/04; E05C 1/00; E05C 1/14; E05F 1/10; E06B 9/00

(52) U.S. Cl. CPC E06B 9/04; E05C 1/006; E05C 1/14; E05F 1/1025; E06B 2009/002

(57) ABSTRACT

The present invention discloses a new type of guardrail door structure, comprising a guardrail door frame internally having a guardrail door body; a connecting mechanism disposed between the guardrail door frame and the guardrail door body; a locking mechanism disposed between the guardrail door frame and the guardrail door body. The present invention connects guardrail door frame to guardrail door body through a connecting mechanism, and adopts a closed structure to keep out the dust and make it safer to use; the guardrail door body is fixed to the guardrail door frame through a locking mechanism, enabling simpler structure and ease of use compared to prior art.

This application claims priority to Chinese Patent Application 202423216192.8, filed on Dec. 25, 2024, which is incorporated herein by reference.

### TECHNICAL FIELD

The present invention relates to the field of guardrail door structure technology, particularly to a new type of guardrail door structure.

### BACKGROUND

When caregivers are unable to take care of infants or pets for various reasons, caregivers are required to provide a safe environment for infants or pets to play. Usually people use guardrails to enclose a safe area, and guardrails are generally equipped with guardrails for the convenience of access.

At present, the connecting mechanism of existing guardrail doors is usually exposed to the outside, such that after long-term use, the dust entering the interior makes it difficult to clean and reduces the service life; currently, the locking mechanisms on the market, which are relatively complex, have many components, and improvement is therefore required.

### SUMMARY

The existing guardrail doors mentioned above are usually exposed to the outside and after long-term use, the dust entering the interior makes it difficult to clean and reduces the service life; currently, the locking mechanisms on the market, which are relatively complex, have many components.

In order to solve the above problems, the present invention provides a new type of guardrail door structure, comprising
a guardrail door frame internally having a guardrail door body;
a connecting mechanism disposed between the guardrail door frame and the guardrail door body;
a locking mechanism disposed between the guardrail door frame and the guardrail door body;
the connecting mechanism comprises a connecting base at the upper end of one side of the guardrail door frame, the connecting base is provided with a circular groove, and a slope slot is provided inside the circular groove, the circular groove is movably fitted with a connecting piece inside, a limit strip is disposed on the connecting piece, the connecting piece is connected to the upper end of one side of the guardrail door body, and the connecting piece is connected to the upper end of one side of the guardrail door body, a pin is provided between the connecting base and the connecting piece, and a spring D is provided between the connecting base and the connecting piece, the upper end of the spring D is pressed against the lower surface of the top of the pin, and the lower end of the spring D is pressed against the lower end of the connecting piece.

As a further technical solution, a shaft lever is provided at the lower end of guardrail door frame, and a secondary connecting piece is movably fitted on the shaft lever and is connected to the lower end of one side of the guardrail door body.

As a further technical solution, the locking mechanism comprises a locking base disposed at the upper end of the other side of guardrail door frame, one side of the locking base is provided with a lock core base, the lock core base is disposed at the upper end of the other side of guardrail door body and internally has a sliding block, a limit plate is provided at the upper end of lock core base, the sliding block is internally and movably fitted with a locking head that is inserted into the locking base through the lock core base, the lock core base is internally provided with a fixed top plate, a spring A is provided between the top plate and the locking head, the lock core base is fitted with a handrail sleeve, a button is connected to the upper pin shaft of lock core base, the button runs through the handrail sleeve, a pressing handle is connected to the lower pin shaft of lock core base, and a spring B is provided between the pressing handle and the lock core base.

As a further technical solution, the limit strip fits with the slope groove.

As a further technical solution, a secondary lock cover is provided at the lower end of the other side of guardrail door frame, a bottom plate is provided on one side of the secondary lock cover, a top head is movably inserted on the other side of the secondary lock cover, a spring C is provided between the top head and the bottom plate, a secondary locking sleeve is provided at the lower end of the other side of the guardrail door body, and the top head is inserted into the secondary locking sleeve through the secondary lock cover.

As a further technical solution, the button fits with the sliding block.

As a further technical solution, one end of the pressing handle fits with the sliding block.

As a further technical solution, a buckle is provided on one side of the pressing handle.

As a further technical solution, a top cap is movably fitted onto the upper end of the connecting piece.

The present invention has the following working principle and beneficial effects:
1. The guardrail door frame is connected to guardrail door body through a connecting mechanism, and a closed structure is used to keep out the dust and make it safer to use.
2. The guardrail door body is fixed to the guardrail door frame through a locking mechanism, enabling simpler structure and ease of use compared to prior art.

### BRIEF DESCRIPTION OF DRAWINGS

In order to more clearly illustrate the technical solution of the embodiments of the present invention, a brief introduction will be given to the accompanying drawings required for the description of the embodiments. Obviously, the accompanying drawings described below are some embodiments of the present invention. Those of ordinary skill in the art can obtain other drawings based on these drawings without creative work.

FIG. 1 is a stereogram of a new type of guardrail door structure provided in the present embodiment;

FIG. 2 is another stereogram of a new type of guardrail door structure provided in the present embodiment;

FIG. 3 is an exploded view of a new type of guardrail door structure provided in the present embodiment;

FIG. 4 is a partial enlarged image of FIG. 2;

FIG. 5 is a partial enlarged image of FIG. 2;

FIG. 6 is a sectional view of parts of a new type of guardrail door structure provided in the present embodiment;

Where: 1. Guardrail door frame; 2. Guardrail door body; 3. Connecting mechanism; 3-1. Connecting base; 3-2. Circular groove; 3-3. Slope slot; 3-4. Connecting piece; 3-5. Limit strip; 3-6. Pin; 3-7. Shaft lever; 3-8. Secondary connecting piece; 3-8. Spring D; 4. Locking mechanism; 4-1. Locking base; 4-2. Lock core base; 4-3. Sliding block; 4-4. Limit plate; 4-5. Locking head; 4-6. Top plate; 4-7. Spring A; 4-8. Handrail sleeve; 4-9. button; 4-10. Pressing handle; 4-11. Spring B; 4-12. Secondary lock cover; 4-13. Bottom plate; 4-14. Top head; 4-15. Spring C; 4-16. Secondary locking sleeve; 4-17. Buckle; 5. Top cap.

### DETAILED DESCRIPTION OF EMBODIMENTS

In order to better understand the above objectives, features, and advantages of the present invention, the present invention will be further illustrated below in conjunction with the accompanying drawings and embodiments. It should be noted that, without conflict, the embodiments and features of the present application can be combined with each other.

Many specific details are elaborated in the following description to facilitate a full understanding of the present invention. However, the present invention can also be implemented in other ways different from those described herein. Therefore, the present invention is not limited to the specific embodiments disclosed in the following specification.

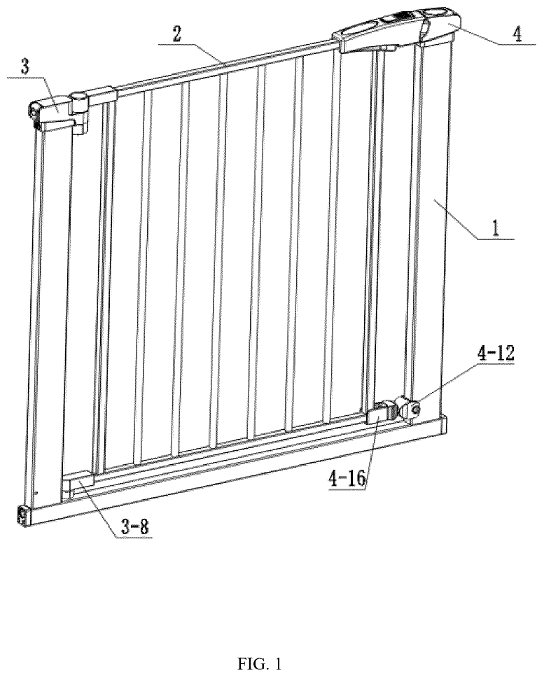

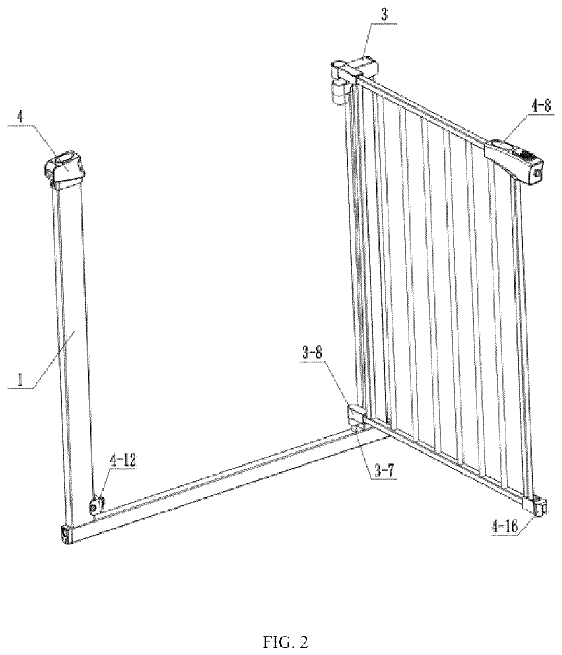

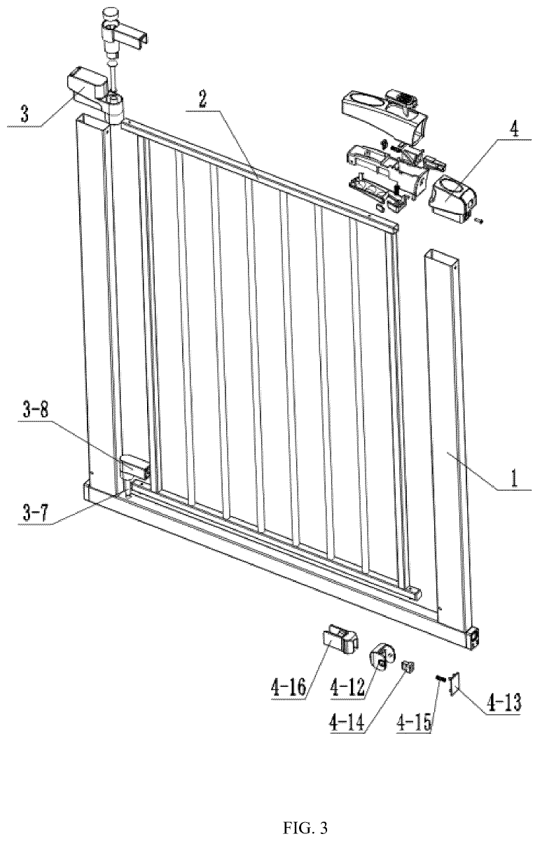

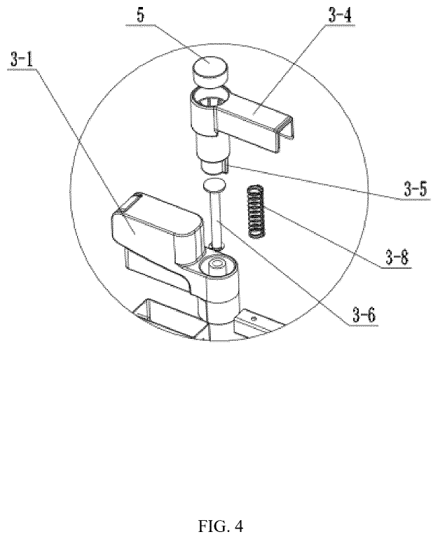

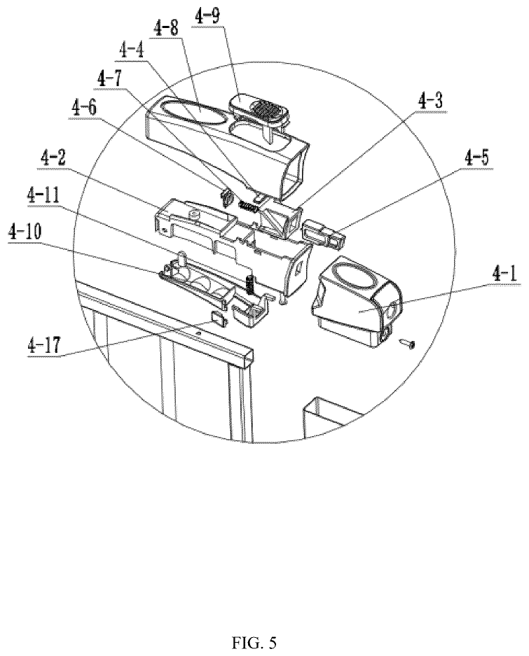

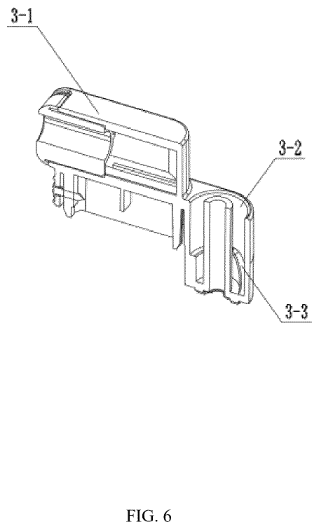

In the embodiment, as shown in FIG. 1-6 of the specification, the solution provides a new type of guardrail door structure, comprising:
a guardrail door frame 1 internally having a guardrail door body 2;
a connecting mechanism 3 disposed between the guardrail door frame 1 and the guardrail door body 2;
a locking mechanism 4 disposed between the guardrail door frame 1 and the guardrail door body 2
the connecting mechanism 3 comprises a connecting base 3-1 at the upper end of one side of the guardrail door frame 1, the connecting base 3-1 is provided with a circular groove 3-2, and a slope slot 3-3 is provided inside the circular groove 3-2, the circular groove 3-2 is movably fitted with a connecting piece 3-4 inside, a limit strip 3-5 is disposed on the connecting piece 3-4, the connecting piece 3-4 is connected to the upper end of one side of the guardrail door body 2, and the connecting piece 3-4 is connected to the upper end of one side of the guardrail door body 2, a pin 3-6 is provided between the connecting base 3-1 and the connecting piece 3-4, and a spring D3-8 is provided between the connecting base 3-1 and the connecting piece 3-4, the upper end of the spring D3-8 is pressed against the lower surface of the top of the pin 3-6, and the lower end of the spring D3-8 is pressed against the lower end of the connecting piece 3-4.

In the embodiment, in order to achieve the connection between the guardrail door frame 1 and the guardrail door body 2, a connecting mechanism 3 is designed, the connecting base 3-1 is installed on the upper end of guardrail door frame 1, the connecting piece 3-4 is installed on the upper end of guardrail door body 2, the connecting piece 3-4 is inserted into the circular groove 3-2, the spring D3-8 is disposed between the connecting base 3-1 and the connecting piece 3-4, and then the pin 3-6 passes through the connecting piece 3-4 and is inserted into the connecting base 3-1. the upper end of spring D3-8 is pressed against the lower surface of the top of the pin 3-6, and the limit strip 3-5 fits with the slope slot 3-3, and when the guardrail door body 2 is opened, the limit strip 3-5 slides on the slope slot 3-3, causing the guardrail door body 2 to move upwards during rotation and, when the guardrail door body 2 is closed, the spring D3-8 exerts force to cause the guardrail door body 2 automatically rotate and close.

As shown in FIG. 1-6 of the specification, a shaft lever 3-7 is provided at the lower end of guardrail door frame 1, and a secondary connecting piece 3-8 is movably fitted on the shaft lever 3-7 and is connected to the lower end of one side of the guardrail door body 2.

In the embodiment, a shaft lever 3-7 is provided at the lower end of guardrail door frame 1, and a secondary connecting piece 3-8 is provided at the lower end of one side of the guardrail door body 2 and is movably fitted on the shaft lever 3-7, so that the guardrail door body 2 can rotate on the guardrail door frame 1 without affecting its up and down movement.

As shown in FIG. 1-6 of the specification, the locking mechanism 4 comprises a locking base 4-1 disposed at the upper end of the other side of guardrail door frame 1, one side of the locking base 4-1 is provided with a lock core base 4-2, the lock core base 4-2 is disposed at the upper end of the other side of guardrail door body 2 and internally has a sliding block 4-3, a limit plate 4-4 is provided at the upper end of lock core base 4-2, the sliding block 4-3 is internally and movably fitted with a locking head 4-5 that is inserted into the locking base 4-1 through the lock core base 4-2, the lock core base 4-2 is internally provided with a fixed top plate 4-6, a spring A4-7 is provided between the top plate 4-6 and the locking head 4-5, the lock core base 4-2 is fitted with a handrail sleeve 4-8, a button 4-9 is connected to the upper pin shaft of lock core base 4-2, the button 4-9 runs through the handrail sleeve 4-8, a pressing handle 4-10 is connected to the lower pin shaft of lock core base 4-2, and a spring B4-11 is provided between the pressing handle 4-10 and the lock core base 4-2.

In the embodiment, the locking base 4-1 is connected to the guardrail door frame 1, the lock core base 4-2 is connected to the guardrail door body 2, the sliding block 4-3 is movably fitted into the lock core base 4-2, the limit plate 4-4 is inserted into the upper end of lock core base 4-2, the locking head 4-5 is movably fitted into the sliding block 4-3, the top plate 4-6 is inserted into the lock core base 4-2, the spring A4-7 is disposed between the top plate 4-6 and the locking head 4-5, the handrail sleeve 4-8 is fitted on the lock core base 4-2, the button 4-9 pin shaft is connected to the upper end of lock core base 4-2, and the pressing handle 4-10 pin shaft is connected to the lower end of lock core base 4-2, spring B4-11 is dispose between the handle 4-10 and lock core base 4-2 and during use, hold the handrail sleeve 4-8 with hands, press the button 4-9 with thumb, and press the pressing handle 4-10 with remaining fingers to release the sliding block 4-3; the button 4-9 pushes sliding block 4-3, causing the locking head 4-5 to move backwards, the limit plate 4-4 restricts the movement position of sliding block 4-3, and the locking head 4-5 leaves the locking base 4-1, such that the guardrail door body 2 can be closed and opened, and springs A4-7 and B4-11 are respectively used for the reset function of the button 4-9 and pressing handle 4-10.

As shown in FIG. 1-6 of the specification, the limit strip 3-5 fits with the slope groove 3-3.

In the embodiment, the limit strip 3-5 slides on the inclined surface of the slope slot 3-3, causing the guardrail door body 2 to move upward during rotation.

As shown in FIG. 1-6 of the specification, a secondary lock cover 4-12 is provided at the lower end of the other side of guardrail door frame 1, a bottom plate 4-13 is provided on one side of the secondary lock cover 4-12, a top head 4-14 is movably inserted on the other side of the secondary lock cover 4-12, a spring C4-15 is provided between the top head 4-14 and the bottom plate 4-13, a secondary locking sleeve 4-16 is provided at the lower end of the other side of the guardrail door body 2, and the top head 4-14 is inserted into the secondary locking sleeve 4-16 through the secondary lock cover 4-12.

In the embodiment, the secondary lock cover 4-12 is disposed at the lower end of the other side of the guardrail door frame 1, the bottom plate 4-13 is disposed at the side of the secondary lock cover 4-12, the top head 4-14 is movably fitted inside the secondary lock cover 4-12, the spring C4-15 is disposed between the bottom plate 4-13 and the top head 4-14, and the auxiliary locking sleeve 4-16 is connected to the lower end of the other side of guardrail door body 2 and, when the guardrail door body 2 is opened, the guardrail door body 2 moves upward, so that the top head 4-14 separates and releases the restriction at the lower end of the auxiliary locking sleeve 4-16. and when the guardrail door body 2 is closed, the top head 4-14 contacts the secondary locking sleeve 4-16 and then moves backward and inserts into the secondary locking sleeve 4-16 under the force of spring C4-15, and is then limited within the secondary locking sleeve 4-16.

As shown in FIG. 1-6 of the specification, the button 4-9 fits with the sliding block 4-3; one end of the pressing handle 4-10 fits with the sliding block 4-3 mutually.

In the embodiment, the button 4-9 fits with the sliding block 4-3, so that when the button 4-9 is pressed down, sliding block 4-3 moves backward, pressing handle 4-10 fits with the sliding block 4-3, and in the locked state, the pressing handle 4-10 is pressed against the rear end of sliding block 4-3 for the purpose of limitation.

As shown in FIG. 1-6 of the specification, a buckle 4-17 is provided on one side of the pressing handle 4-10.

In the embodiment, the buckle 4-17 is used to fix pressing handle 4-10 onto the guardrail door body 2.

As shown in FIG. 1-6 of the specification, a top cap is movably fitted onto the upper end of the connecting piece 3-4.

In the embodiment, the top cap is fitted onto the connecting piece 3-4.

Only preferred embodiments of the present invention are described above, and it is not intended to limit the present invention in any other form. Any person skilled in the art may use the disclosed technical content to modify or adapt equivalent embodiments to other fields. However, any simple modifications, equivalent changes, and adaptations made to the above embodiments based on the technical essence of the present invention without departing from the technical solution of the present invention still fall within the protection scope of the technical solution of the present invention.

What is claimed is:

1. A new type of guardrail door structure, comprising
a guardrail door frame (1) internally having a guardrail door body (2);
a connecting mechanism (3) disposed between the guardrail door frame (1) and the guardrail door body (2);
a locking mechanism (4) disposed between the guardrail door frame (1) and the guardrail door body (2);
the connecting mechanism (3) comprises a connecting base (3-1) at the upper end of one side of the guardrail door frame (1), the connecting base (3-1) is provided with a circular groove (3-2), and a slope slot (3-3) is provided inside the circular groove (3-2), the circular groove (3-2) is movably fitted with a connecting piece (3-4) inside, a limit strip (3-5) is disposed on the connecting piece (3-4), the connecting piece (3-4) is connected to the upper end of one side of the guardrail door body (2), and the connecting piece (3-4) is connected to the upper end of one side of the guardrail door body (2), a pin (3-6) is provided between the connecting base (3-1) and the connecting piece (3-4), and a spring D (3-8) is provided between the connecting base (3-1) and the connecting piece (3-4), the upper end of the spring D (3-8) is pressed against the lower surface of the top of the pin (3-6), and the lower end of the spring D (3-8) is pressed against the lower end of the connecting piece (3-4).

2. A new type of guardrail door structure according to claim 1, wherein a shaft lever (3-7) is provided at the lower end of guardrail door frame (1), and a secondary connecting piece (3-8) is movably fitted on the shaft lever (3-7) and is connected to the lower end of one side of the guardrail door body (2).

3. A new type of guardrail door structure according to claim 1, wherein the locking mechanism (4) comprises a locking base (4-1) disposed at the upper end of the other side of guardrail door frame (1), one side of the locking base (4-1) is provided with a lock core base (4-2), the lock core base (4-2) is disposed at the upper end of the other side of guardrail door body (2) and internally has a sliding block (4-3), a limit plate (4-4) is provided at the upper end of lock core base (4-2), the sliding block (4-3) is internally and movably fitted with a locking head (4-5) that is inserted into the locking base (4-1) through the lock core base (4-2), the lock core base (4-2) is internally provided with a fixed top plate (4-6), a spring A (4-7) is provided between the top plate (4-6) and the locking head (4-5), the lock core base (4-2) is fitted with a handrail sleeve (4-8), a button (4-9) is connected to the upper pin shaft of lock core base (4-2), the button (4-9) runs through the handrail sleeve (4-8), a pressing handle (4-10) is connected to the lower pin shaft of lock core base (4-2), and a spring B (4-11) is provided between the pressing handle (4-10) and the lock core base (4-2).

4. A new type of guardrail door structure according to claim 1, wherein the limit strip (3-5) fits with the slope groove (3-3).

5. A new type of guardrail door structure according to claim 3, wherein a secondary lock cover (4-12) is provided at the lower end of the other side of guardrail door frame (1), a bottom plate (4-13) is provided on one side of the secondary lock cover (4-12), a top head (4-14) is movably inserted on the other side of the secondary lock cover (4-12), a spring C (4-15) is provided between the top head (4-14) and the bottom plate (4-13), a secondary locking sleeve (4-16) is provided at the lower end of the other side of the guardrail door body (2), and the top head (4-14) is inserted into the secondary locking sleeve (4-16) through the secondary lock cover (4-12).

6. A new type of guardrail door structure according to claim 3, wherein the button (4-9) fits with the sliding block (4-3).

7. A new type of guardrail door structure according to claim 3, wherein one end of the pressing handle (4-10) fits with the sliding block (4-3).

8. A new type of guardrail door structure according to claim 3, wherein a buckle (4-17) is provided on one side of the pressing handle (4-10).

9. A new type of guardrail door structure according to claim 3, wherein a top cap (5) is movably fitted onto the upper end of the connecting piece (3-4).
